(19) United States
(12) Patent Application Publication
(10) Pub. No.: US 2026/0162632 A1
(43) Pub. Date: Jun. 11, 2026

(54) GUITAR PICK HOLDER

(71) Applicant: Examentum LLC, Westminster, CO (US)

(72) Inventor: Andrew Stoner, Westminster, CO (US)

(21) Appl. No.: 18/976,242

(22) Filed: Dec. 10, 2024

(51) Int. Cl. G10D 3/173

(52) U.S. Cl. CPC G10D 3/173

(57) ABSTRACT

A plectrum holding device may include a mounting member configured to be mounted to the guitar, a base removably coupled to the mounting member, and a holder coupled to the base. The holder includes a platform, an array of posts extending from the platform, and a plurality of tabs extending from each post. The holder is configured to hold at least one plectrum between at least a pair of adjacent posts of the array of posts.

### FIELD OF THE DISCLOSURE

The present invention relates to a holding device, and more specifically to a pick holding device for guitar picks.

### BACKGROUND OF THE DISCLOSURE

A guitar pick is a plectrum used to strum chords or to sound individual notes on a guitar. Guitar picks come in a variety of shapes, sizes, and thicknesses for serving different purposes. Different guitar picks may be used with different guitars, or for different songs with the same guitar.

### SUMMARY OF THE DISCLOSURE

The present disclosure provides, in one aspect, a plectrum holding device configured to couple to a guitar and hold at least one plectrum, the plectrum holding device including a mounting member configured to be mounted to the guitar; a base removably coupled to the mounting member; and a holder coupled to the base, the holder including a platform, an array of posts extending from the platform, and a plurality of tabs extending from each post, wherein the holder is configured to hold at least one plectrum between at least a pair of adjacent posts of the array of posts.

The present disclosure provides, in another aspect, a plectrum holding device configured to hold at least one plectrum, the plectrum holding device including: a platform; a plurality of posts extending from the platform and each post defining a longitudinal axis this is perpendicular to the platform; and a plurality of tabs extending from each post and spaced equidistant apart along a direction parallel to the longitudinal axis, wherein, when a plectrum is inserted into the plectrum holding device, each post that engages the plectrum deflects away from the plectrum to accommodate the plectrum.

Other features and aspects of the invention will become apparent by consideration of the following detailed description and accompanying drawings.

### BRIEF DESCRIPTION OF THE DRAWINGS

FIG. 1 is an exploded view of a guitar pick holding device in accordance with an embodiment of the disclosure, illustrating a mounting member, a base, and a holder configured to holder one or more guitar picks.

FIG. 2 is a perspective view of the guitar pick holding device of FIG. 1 coupled to a guitar.

FIG. 3 is a cross-section view of the guitar pick holding device of FIG. 1.

FIG. 4 is an enlarged plan view of a portion of the guitar pick holding device of FIG. 1, illustrating the holding device having an array of posts and a plurality of tabs extending from each post that are configured to engage the one or more guitar picks.

FIG. 5 is an enlarged top view of a portion of the guitar pick holder of FIG. 1, illustrating the array of posts and the plurality of tabs extending from each post.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

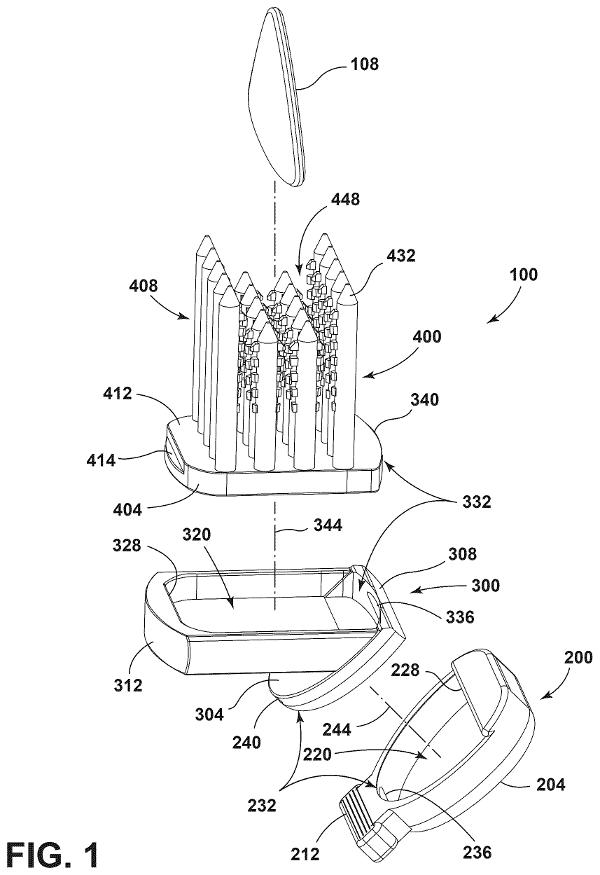

FIG. 1 illustrates a guitar pick holding device or plectrum holding device 100 that is configured to couple to a guitar 104 and hold one or more guitar picks or plectrums 108. The plectrum holding device 100 of the illustrated embodiment includes a mounting member 200, a bracket 300, and a holder 400. The plectrum holding device 100 is preferably coupled to the guitar 104 in a location that does not interfere with acoustics of the guitar 104 (e.g., the neck, an area of the body, the headstock, etc.). The holder 400 accommodates the one or more plectrums 108 that come in a wide variety of shapes, sizes, and thicknesses, as explained in further detail below.

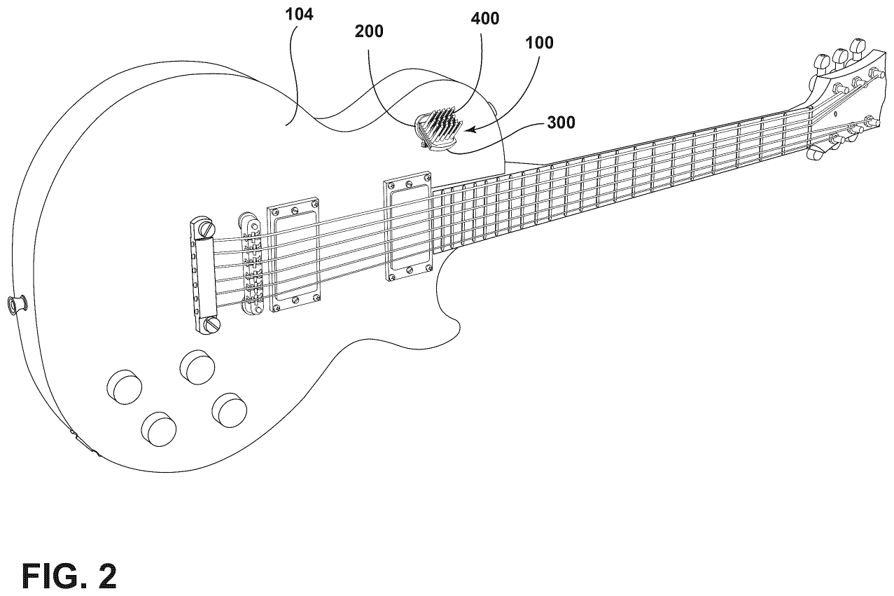

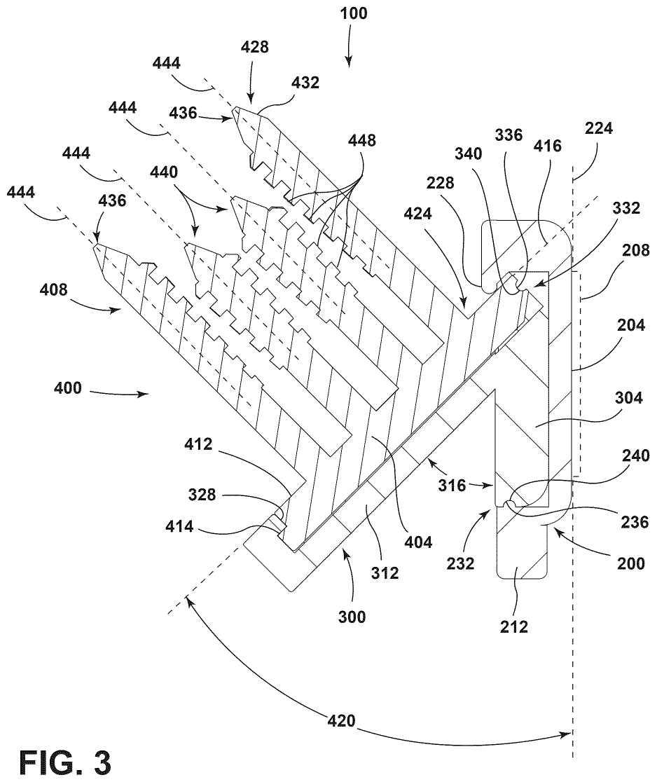

With reference to FIGS. 1 and 2, the mounting member 200 is configured to couple to the guitar 104. Specifically, the mounting member 200 includes a mounting surface 204 that engages and selectively mounts to the guitar 104 via an adhesive tape 208 (FIG. 3). In other embodiments, the mounting surface 204 may be permanently affixed to the guitar 104 via glue or some other fastening mechanism. The mounting member 200 further includes a handle 212 that a user may grasp to maneuver the mounting member 200 relative to the guitar 104 during placement. A user may also grasp the handle 212 to remove the mounting member 200 from the guitar 104.

With reference to FIGS. 1-3, the mounting member 200 further includes a first pocket 220 on an opposite side from the mounting surface 204. The mounting surface 204 defines a first plane 224 that is generally parallel or co-planar to the area of the guitar 104 to which the mounting surface 204 is mounted. The mounting member 200 further includes a first shoulder or overhang 228 that extends (i.e., cantilevers) over a portion of the first pocket 220. The first pocket 220 selectively receives the bracket 300. First, a portion of the bracket 300 is placed under the first overhang 228 and then the remaining portion of the bracket 300 is rotated into the first pocket 220. Once installed, the first overhang 228 overlaps at least a portion of the bracket 300 and the holder 400. The bracket 300 is inhibited from being removed from the first pocket 220 due to a first quick-disconnect mechanism 232 (FIG. 1). The illustrated first quick-disconnect mechanism 232 is a snap-fit mechanism, while in other embodiments, the first quick-disconnect mechanism 232 may alternatively be press-fit or some other similar type of mechanism. The first quick-disconnect mechanism 232 includes a first protrusion 236 and a first groove 240 (FIG. 3) that receives the first protrusion 236. The first protrusion 236 is disposed within the first pocket 220 and extends radially inward from the first pocket 220 along a direction generally perpendicular to a first pocket axis 244. The first groove 240 is disposed on the bracket 300. The bracket 300 may be removed from the first pocket 220 upon a sufficient force pulling the bracket 300 out of the first pocket 220, resulting in the first protrusion 236 sliding out of the first groove 240.

With continued reference to FIGS. 1-3, the bracket 300 includes a base 304 that is generally circular in shape with a truncated end 308. The truncated end 308 is configured to be received under the first overhang 228 while the base 304 is received within the first pocket 220. The bracket 300 further includes a mounting arm 312 that extends from the base 304 at a bracket angle 316. The illustrated bracket angle 316 is between approximately 10 degrees to approximately 80 degrees. Specifically, the illustrated bracket angle 316 defined between the base 304 and the mounting arm 312 is approximately 45 degrees.

Furthermore, the bracket 300 includes a second pocket 320 and a second shoulder or overhang 328 that extends (i.e., cantilevers) over a portion of the second pocket 320. The second pocket 320 is disposed on the mounting arm 312. The second pocket 320 selectively receives the holder 400. First, a portion of the holder 400 is placed under the second overhang 328 and then the remaining portion of the holder 400 is rotated into the second pocket 320. Once installed, the second overhang 328 overlaps at least a portion of the holder 400. The holder 400 is inhibited from being removed from the second pocket 320 due to a second quick-disconnect mechanism 332 (FIG. 1). The illustrated second quick-disconnect mechanism 332 is a snap-fit mechanism, while in other embodiments, the second quick-disconnect mechanism 332 may alternatively be press-fit or some other similar type of mechanism. The second quick-disconnect mechanism 332 includes a second protrusion 336 and a second groove 340 (FIG. 3) that receives the second protrusion 336. The second protrusion 336 is disposed within the second pocket 320 and extends radially inward from the second pocket 320 along a direction generally perpendicular to a second pocket axis 344. The second groove 340 is disposed on the holder 400. The holder 400 may be removed from the second pocket 320 upon a sufficient force pulling the holder 400 out of the second pocket 320, resulting in the second protrusion 336 sliding out of the second groove 340.

With reference to FIGS. 3-5, the holder 400 includes a platform 404 and a plurality of posts 408 extending from the platform 404. Specifically, the plurality of posts 408 extend from an upper surface 412 of the platform 404. A shoulder 414 is formed on the platform 404 that is configured to engage the second overhang 328. The upper surface 412 defines a second plane 416. When the bracket 300 and the holder 400 are coupled to the mounting member 200, a mounting angle 420 is formed between the first plane 224 and the second plane 416, as illustrated in FIG. 3. The second plane 416 is acutely angled relative to the first plane 224. The illustrated mounting angle 420 is the same as the bracket angle 316, although in other embodiments the mounting angle 420 may be different from the bracket angle 316. The illustrated mounting angle 420 is between approximately 5 degrees to approximately 90 degrees. Specifically, the illustrated mounting angle 420 defined between the first plane 224 and the second plane 416 is approximately 45 degrees. In some embodiments, the mounting angle 420 may alternatively be zero, such that there is no mounting angle 420 because the first plane 224 and the second plane 416 are coplanar or parallel. In other words, the plurality of posts 408 may extend perpendicular relative to the platform 404 and the mounting surface 204.

With continued reference to FIGS. 3-5, the plurality of posts 408 are arranged as an array or grid of posts, such that the plurality of posts 408 define rows and columns of posts in a grid pattern. In the illustrated embodiment, there are 4 rows and 5 columns of posts, while in other embodiments, there may alternatively be greater or fewer rows and columns of posts. The plurality of posts 408 each include a first end 424 coupled to the platform 404 and a second, distal end 428 disposed opposite the first end 424. The second end 428 is also a free end that defines a frustoconical tip 432 to allow the one or more plectrums 108 to easily insert into the plurality of posts 408 without jamming against the plurality of posts 408 during entry. The plurality of posts 408 also include a first series of posts 436 defining a first height H1 measured from the first end 424 to the second end 428 and a second series of posts 440 defining a second height H2 measured from the first end 424 to the second end 428, wherein the first height H1 is greater than the second height H2. The second series of posts 440 are disposed between the first series of posts 436. Preferably, the first height H1 is approximately 20 millimeters to 25 millimeters and, more specifically, approximately 21 millimeters, whereas the second height H2 is approximately 10 millimeters to approximately 18 millimeters and, more specifically, approximately 16.5 millimeters.

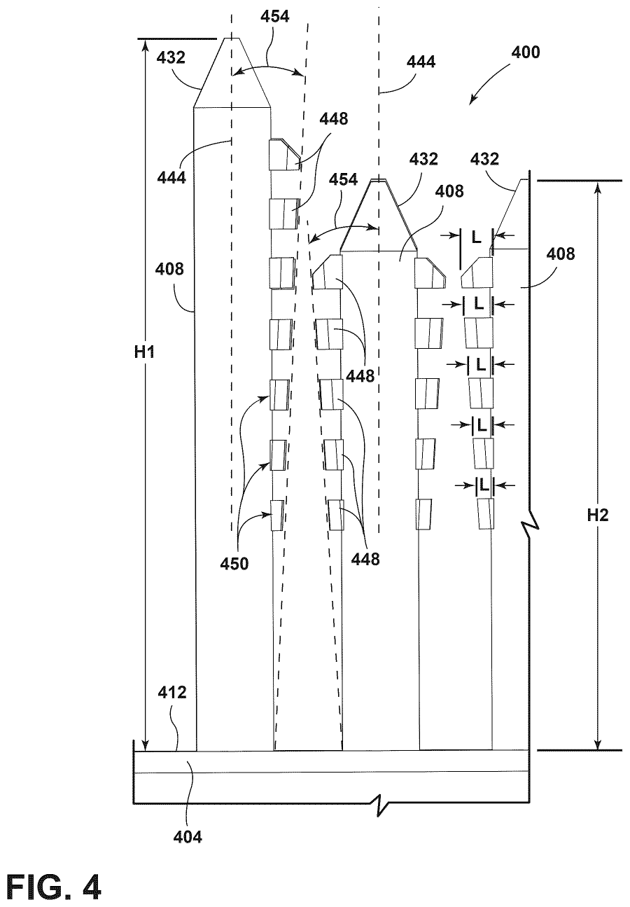

Each post of the plurality of posts 408 further defines a longitudinal axis 444 that is perpendicular to the platform 404. Also, each post of the plurality of posts 408 include a plurality of tabs 448 that extend away from each post in a direction perpendicular to the longitudinal axis 444. The plurality of tabs 448 are spaced equidistant apart along a direction parallel to the longitudinal axis 444. Each tab of the plurality of tabs 448 defines a length L, where the length L of the tabs adjacent the second end 428 is greater than the length L of the tabs closer to the first end 424. In other words, the length L of the plurality of tabs 448 measured radially outward from the longitudinal axis 444 gradually decreases along a direction from the second end 428 toward the first end 424 of the plurality of posts 408. As a result, each column 452 of the plurality of tabs 448 collectively define a taper angle 454, wherein the taper angle 454 is approximately 1 degree to 10 degrees relative to the longitudinal axis 444. Specifically, the taper angle 454 is approximately 2 degrees to 5 degrees relative to the longitudinal axis 444. Ultimately, the taper angle 454 is dependent upon the spacing between adjacent posts 408, as explained in further detail below. As shown in FIG. 4, the taper angle 454 intersects a circumference of each post 408 at the first end 424.

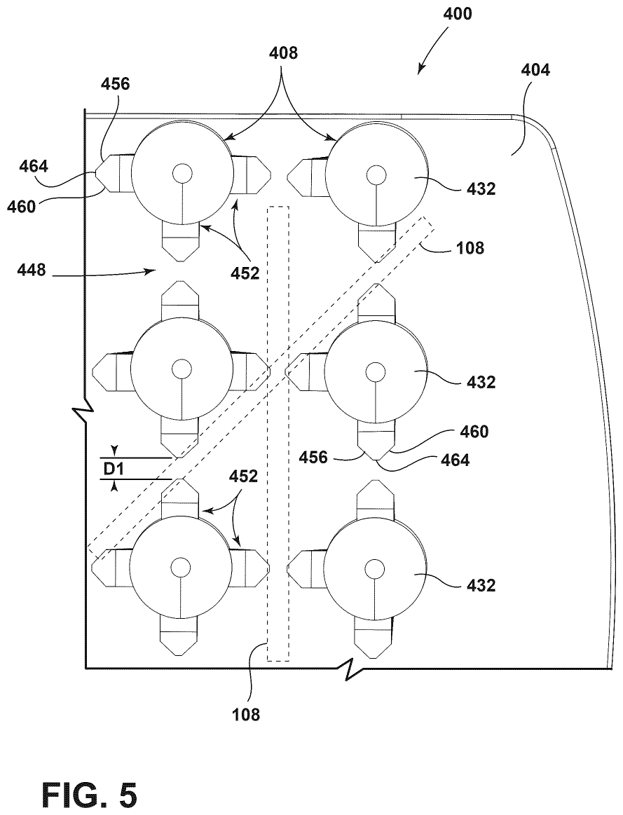

In the illustrated embodiment, the columns 452 of the plurality of tabs 448 at least define a first column of tabs and a second column of tabs, which are spaced approximately 90 degrees apart from each other, as shown in FIG. 5. In other embodiments, the columns 452 may be angularly spaced more or less than 90 degrees apart from each other. Also, as best illustrated in FIG. 5, some posts 408 have two columns 452, some posts 408 have three columns, and some posts 408 have four columns 452. In other embodiments, each post 408 may have four columns 452 of tabs 448 each spaced approximately 90 degrees apart from each other. As best shown in FIG. 4, the plurality of tabs 448 also form rows 450. The rows 450 of the plurality of tabs 448 are equally spaced apart from each other as measured along the first and second height H1, H2. The rows 450 space out the plurality of tabs 448 to provide added flexibility to the posts 408. If, for example, the columns 452 consisted of one tab that extended along a majority of the first and second height H1, H2 of the post 408 without tabs being spaced apart by the rows 450, then the posts 408 may become insufficiently rigid and inhibit bending (i.e., deforming, deflecting, etc.) of the posts 408 when receiving plectrum(s) 108.

With continued reference to FIG. 5, the plurality of tabs 448 each have a first chamfered edge 456, a second chamfered edge 460, and a flat tip 464. A minimum distance D1 is defined between the flat tips 464 on opposing tabs 448, as shown in FIG. 5. The minimum distance D1 is equal to or less than 0.45 millimeters because plectrums typically have a thickness ranging between approximately 0.45 millimeters to approximately 2.0 millimeters. Thus, the minimum distance D1 creates an interference fit between the one or more plectrums 108 and the plurality of tabs 448, enabling the opposing tabs 448 to grip the one or more plectrums 108. To accommodate the thickness of the one or plectrums 108, the posts 408 that grip the one or more plectrums 108 deflect or deform away from the one or more plectrums 108. In other words, the posts 408 that engage the one or more plectrums 108 bend to accommodate and grip the plectrum(s) 108, such that those posts 408 are no longer perpendicular to the platform 404. The one or more plectrums 108 interface with the flat tip 464 when inserted into the plurality of posts 408 in an orientation perpendicular to the plurality of tab 448. In contrast, the one or more plectrums 108 interface with either the first chamfered edge 456 or the second chamfered edge 460 when inserted into the plurality of posts 408 in an orientation angled approximately 45 degrees relative to the plurality of tabs 448. The plurality of posts 408 may be spaced apart at various distances about the platform 404, but the minimum distance D1 is always equal to or less than 0.45 millimeters. This means that the length L of the plurality of tabs 448 may change to maintain the minimum distance D1 depending on the spacing between the posts 408. The taper angle 454 may also change depending on the length L of the plurality of tabs 448 and the spacing between the posts 408.

The illustrated holder 400 is composed of nylon which gives the plurality of posts 408 proper durability, rigidity, and flexibility. In other embodiments, the holder 400 may alternatively be composed of other similar materials.

During use, the plectrum holding device 100 is coupled to a guitar 104 and one or more plectrums 108 are held between at least a pair of adjacent posts 408, so the user can easily grasp and store one or more plectrums 108. Specifically, the mounting member 200 is coupled to the guitar 104 using the adhesive tape 208, at which point the bracket 300 is coupled to the mounting member 200 via snap-fit (i.e., quick-disconnect mechanism 232) and the holder 400 is coupled to the bracket 300 via snap-fit (i.e., quick-disconnect mechanism 332). Specifically, the truncated end 308 of the bracket 300 is placed under the first overhang 228, at which point the bracket 300 is rotated into the first pocket 220 until the first groove 240 receives the first protrusion 236. Now, the shoulder 414 of the holder 400 is placed under the second overhang 328, at which point the holder 400 is rotated into the second pocket 320 until the second groove 340 receives the second protrusion 336. The bracket 300 and the holder 400 may also be quickly uncoupled from the mounting member 200 and attached to a separate mounting member on another guitar, so the user can continue using the same plectrums 108. In general, plectrums come in a variety of thicknesses ranging between approximately 0.45 millimeters to approximately 2.0 millimeters. The minimum distance D1 (FIG. 5) between adjacent tabs 448 on opposing posts 408 in less than 0.45 millimeters, such that there is an interference fit between the one or more plectrums 108 and the plurality of tabs 448. As a result, the posts 408 that receive the one or more plectrums 108 deflect or deform away from the one or more plectrums 108. In other words, the posts 408 that engage the one or more plectrums 108 bend to accommodate and grip the plectrum(s) 108, such that those posts 408 are no longer perpendicular to the platform 404. The posts 408 bias to their default position after the plectrum(s) 108 are removed, such that the posts 408 once again become perpendicular to the platform 404. A user may insert the one or more plectrums 108 into the holder 400 in a variety of orientations. For example, the plectrum(s) 108 may be inserted into the plurality of posts 408 in an orientation where the plectrum(s) 108 are generally perpendicular to the plurality of tabs 448 that the plectrum(s) 108 are engaged with. In this orientation, the plectrum(s) 108 are engaged with the flat tip 464 of the tabs 448. Similarly, the plectrum(s) 108 may be inserted into the plurality of posts 408 in an orientation where the plectrum(s) 108 are generally obliquely angled relative to the plurality of tabs 448 that the plectrum(s) 108 are engaged with. In this orientation, the plectrum(s) 108 are engaged with the chamfered edges 456, 460 of the tabs 448. A user may remove the one or more plectrums 108 by pulling on the plectrum(s) 108 with sufficient force to overcome the gripping force of the plurality of tabs 448.

Although the disclosure has been described in detail with reference to certain preferred embodiments, variations and modifications exist within the scope and spirit of one or more independent aspects of the disclosure as described. Various features and advantages of the disclosure are set forth in the following claims.

What is claimed is:

1. A plectrum holding device configured to couple to a guitar and hold at least one plectrum, the plectrum holding device comprising:
a mounting member configured to be mounted to the guitar;
a base removably coupled to the mounting member; and
a holder coupled to the base, the holder including
a platform,
an array of posts extending from the platform, and
a plurality of tabs extending from each post,
wherein the holder is configured to hold at least one plectrum between at least a pair of adjacent posts of the array of posts.

2. The plectrum holding device of claim 1, wherein the platform includes a surface from which the array of posts extend, the surface defining a first plane, and wherein the mounting member includes a mounting surface that defines a second plane that is acutely angled relative to the first plane.

3. The plectrum holding device of claim 2, wherein the first plane and the second plane are angled approximately 20 degrees to approximately 80 degrees relative to each other.

4. The plectrum holding device of claim 2 wherein the first plane and the second plane are angled approximately 45 degrees relative to each other.

5. The plectrum holding device of claim 1, wherein each post of the array of posts defines a longitudinal axis that is perpendicular to the platform.

6. The plectrum holding device of claim 1, wherein each post of the array of posts defines a first end coupled to the platform and a second end opposite the first end, wherein the second end includes a frustoconical tip.

7. The plectrum holding device of claim 6, wherein the array of posts include a first series of posts defining a first height measured from the first end to the second end and a second series of posts defining a second height measured from the first end to the second end, wherein the first height is greater than the second height.

8. The plectrum holding device of claim 1, wherein the mounting member includes a first pocket that selectively receives the base via a first quick-disconnect mechanism.

9. The plectrum holding device of claim 8, wherein the base includes a second pocket that selectively receives the platform of the holder via a second quick-disconnect mechanism.

10. The plectrum holding device of claim 8, wherein the mounting member includes an overhang that cantilevers over a portion of the first pocket and overlaps the base and the platform when the mounting member, the base, and the holder are coupled together.

11. A plectrum holding device configured to hold at least one plectrum, the plectrum holding device comprising:
a platform;
a plurality of posts extending from the platform and each post defining a longitudinal axis this is perpendicular to the platform; and
a plurality of tabs extending from each post and spaced equidistant apart along a direction parallel to the longitudinal axis,
wherein, when a plectrum is inserted into the plectrum holding device, each post that engages the plectrum deflects away from the plectrum to accommodate the plectrum.

12. The plectrum holding device of claim 11, wherein each post of the plurality of posts defines a first end coupled to the platform and a second end opposite the first end, wherein the second end includes a frustoconical tip.

13. The plectrum holding device of claim 12, wherein the plurality of posts includes a first series of posts defining a first height measured from the first end to the second end and a second series of posts defining a second height measured from the first end to the second end, wherein the first height is greater than the second height.

14. The plectrum holding device of claim 12, wherein a length of the plurality of tabs measured radially outward from the longitudinal axis gradually decreases along a direction from the second end towards the first end of the plurality of posts.

15. The plectrum holding device of claim 11, wherein the plurality of tabs collectively define a taper angle, wherein the taper angle is approximately 2 degrees to 5 degrees relative to the longitudinal axis.

16. The plectrum holding device of claim 15, wherein the taper angle intersects a circumference of each post.

17. The plectrum holding device of claim 11, wherein the plurality of tabs each have a first chamfered edge, a second chamfered edge, and a flat tip, wherein the plectrum interfaces with the flat tip when inserted into the plurality of posts in an orientation perpendicular to the plurality of tab.

18. The plectrum holding device of claim 11, wherein the plurality of tabs each have a first chamfered edge, a second chamfered edge, and a flat tip, wherein the plectrum interfaces with either the first chamfered edge or the second chamfered edge when inserted into the plurality of posts in an orientation angled approximately 45 degrees relative to the plurality of tabs.

19. The plectrum holding device of claim 11, wherein the plurality of tabs on each post define at least a first column of tabs and a second column of tabs, wherein the first column of tabs are spaced approximately 90 degrees apart from the second column of tabs.

20. The plectrum holding device of claim 11, wherein the plurality of posts are arranged in a grid pattern.
